(19) United States
(12) Patent Application Publication
(10) Pub. No.: US 2017/0173828 A1
(43) Pub. Date: Jun. 22, 2017

(54) MOLD FOR MOLDING EXPANDED RESIN AND PROCESS FOR PRODUCING SAME

(71) Applicant: SHIN-ETSU CHEMICAL CO., LTD., Tokyo (JP)

(72) Inventors: Ryota ISHIMOTO, Osaka-shi (JP); Takashi HAGIWARA, Osaka-shi (JP); Masato UEYAMA, Osaka-shi (JP); Mamoru TESHIGAWARA, Annaka-shi (JP); Takafumi SAKAMOTO, Annaka-shi (JP)

(73) Assignee: SHIN-ETSU CHEMICAL CO., LTD., Tokyo (JP)

(21) Appl. No.: 15/116,080

(22) PCT Filed: Nov. 17, 2014
(86) PCT No.: PCT/JP2014/080296

§ 371 Date: Aug. 2, 2016

(30) Foreign Application Priority Data
Feb. 3, 2014 (JP) 2014-018389

(51) Int. Cl. B29C 44/58; B29C 44/34

(52) U.S. Cl. CPC B29C 44/58; B29C 44/3461; B29K 2025/06

(57) ABSTRACT

A mold for molding an expanded resin, wherein a silicone rubber layer (40) having a JIS-A hardness of 20 to 70 is formed as a heat-insulating layer at least on a part or the whole of the inner wall surface that forms a cavity (20) of a mold main body (10) which is for use in molding an expanded resin and which is made of an aluminum material. This mold for molding an expanded resin is effectively usable in molding expanded polystyrene or the like by a bead molding method, and can produce a molded product of an expanded resin with high thermal efficiency by virtue of high heat insulation performance. Further, the mold can be easily produced with good execution efficiency.

### TECHNICAL FIELD

This invention relates to a mold for molding expanded resins such as expanded polystyrene that is made of an aluminum material, and to a method of manufacturing the mold.

### BACKGROUND ART

The expandable bead process for molding expanded polystyrene has hitherto been known. In this process, the cavity of an aluminum mold is filled with an expanded polystyrene (EPS) feedstock, and steam at 100° C. and approximately 1 atmosphere is typically introduced into the mold to heat and melt the EPS beads, thereby giving an expanded polystyrene molded product.

However, because aluminum has a good heat conductivity, a great deal of heat dissipates from the aluminum mold in the heating step, generally making it necessary for the mold to be heated and kept warm with a large amount of heating medium such as steam in order to maintain the mold temperature at a given level during the molding operation. This lowers the thermal efficiency, resulting in a sharp rise in raw material costs.

Heat-insulating measures are thus carried out to prevent the loss of heat from the aluminum mold. In the prior art, part of the inner wall that defines the mold cavity has been rendered thermally insulating with a lining sheet of ethylene-propylene-diene (EPDM) rubber. However, because such an EPDM rubber lining sheet does not adhere to the aluminum mold, the sheet has been bolted together with an aluminum plate to the mold back plate. Unfortunately, this increases costs and, moreover, is difficult to carry out. In addition, applying this approach to the entire mold is challenging and generally can be done only on part of the movable side of the back plate. Hence, it has not been possible to impart sufficient thermal insulating properties to the entire mold.

Prior technical literature relating to the invention includes the following.

### PRIOR ART DOCUMENTS

### Patent Documents

Patent Document 1: JP-A 2010-260254

Patent Document 2: JP-A 2013-221306

Patent Document 3: WO 2013/008372

### SUMMARY OF THE INVENTION

### Problems to be Solved by the Invention

In light of the above circumstances, one object of the invention is to provide a highly heat-efficient mold for molding expanded resin in which a heat-insulating layer can be easily formed on at least a cavity-defining inner wall of an aluminum body of the mold, enabling heat dissipation from the mold to be markedly reduced. A further object of the invention is to provide a method for producing such a mold.

### Means for Solving the Problems

As a result of extensive investigations, the inventors have discovered that by applying a liquid room temperature-vulcanizable (RTV) silicone rubber composition onto part or all of at least a cavity-defining inner wall of the body of a mold for molding expanded resin, which mold body is made of an aluminum material, or also, in addition to the inner wall, part or all of an outer wall (outer surface) of the mold body, and drying and curing the applied composition to form a silicone rubber layer having a JIS-A hardness, as determined in accordance with JIS K 6249, of from 20 to 70, a silicone rubber coating layer having excellent adherence to the aluminum mold can be formed, which silicone rubber layer acts as a heat-insulating layer that effectively suppresses heat dissipation from the mold body and improves heat efficiency. The inventors have also found that this heat-insulating layer forming method is very easy to carry out, enabling a silicone rubber layer of the required thickness to be readily formed. In this invention, “room temperature” means 25° C.±10° C.

[1] A mold for molding expanded resin, the mold being characterized by comprising a mold body that is made of an aluminum material and has an inner wall which defines a cavity and on part or all of which is formed, as a heat-insulating layer, a layer of silicone rubber having a JIS-A hardness of from 20 to 70.

[2] The mold of [1], wherein a silicone rubber layer having a JIS-A hardness of from 20 to 70 is additionally formed on part or all of an outer wall of the mold body.

[3] The mold of [1] or [2], wherein the expanded resin is expanded polystyrene which is molded by filling the cavity of the mold body with expandable polystyrene beads and steam-heating the mold body.

[4] The mold of any one of [1] to [3], wherein the silicone rubber layer has a thickness of from 0.5 to 5 mm.

[5] The mold of any one of [1] to [4], wherein the silicone rubber layer is a cured product of a room temperature-vulcanizable silicone rubber composition.

[6] A method of manufacturing a mold for molding expanded resin, the method being characterized by applying, to part or all of at least a cavity-defining inner wall of a mold body which is adapted for molding an expanded resin and is made of an aluminum material, a liquid room temperature-vulcanizable silicone rubber composition that has a viscosity at 25° C. of from 0.01 to 100 Pa·s and gives a cured product having a JIS-A hardness of from 20 to 70, and then drying and curing the applied composition to form a silicone rubber layer as a heat-insulating layer on the inner wall.

[7] The manufacturing method of [6], which further comprises applying the liquid room temperature-vulcanizable silicone rubber composition of claim 6 to part or all of an outer wall of the mold body, and then drying and curing the applied composition to form a silicone rubber layer on the outer wall.

[8] The manufacturing method of [6] or [7], wherein the expanded resin is expanded polystyrene which is formed by filling the cavity of the mold body with expandable polystyrene beads and steam-heating the mold body to mold expanded polystyrene.

[9] The manufacturing method of any one of [6] to [8], wherein the silicone rubber layer has a thickness of from 0.5 to 5 mm.

[10] The manufacturing method of any one of [6] to [9] which is characterized by comprising the step of twice applying and drying the liquid room temperature-vulcanizable silicone rubber composition.

### Advantageous Effects of the Invention

The inventive mold for molding expanded resin can be effectively used for molding expanded polystyrene and the like by a bead molding process, has a high heat-insulating performance and is thus capable of heat-efficiently molding expanded resin molded products, and moreover can be easily manufactured.

The silicone rubber layer, along with having excellent heat-insulating properties, adheres well to the aluminum mold and fully conforms to thermal expansion of the mold body made of an aluminum material. Also, particularly when a liquid silicone rubber composition having a viscosity at 25° C. of 0.01 to 100 Pa·s is used to form this silicone rubber layer, a silicone rubber layer of sufficient thickness can be coated onto the inner wall of the mold body, enabling a silicone rubber layer of sufficient thickness to be formed, as a result of which a good heat-insulating performance can be imparted. Furthermore, the liquid silicone rubber composition can be easily applied by a method such as brush coating, and thus is easy to work with.

### BRIEF DESCRIPTION OF THE DIAGRAMS

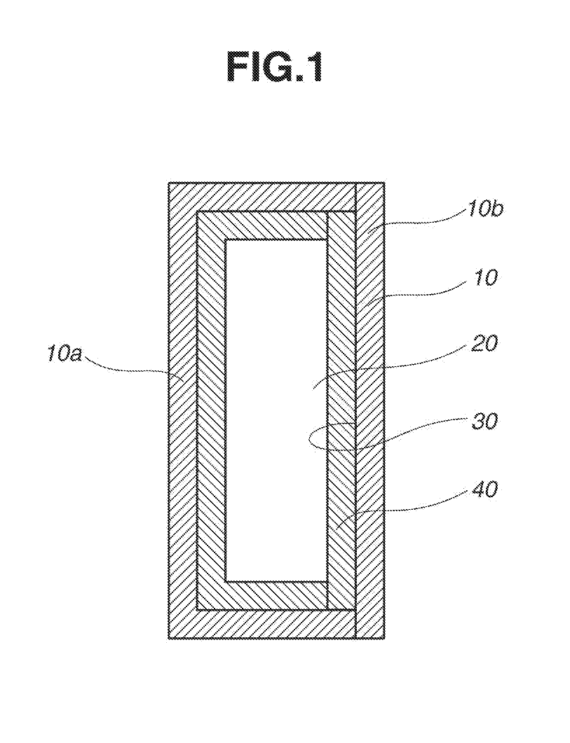

FIG. 1 is a schematic cross-sectional diagram showing an embodiment of a mold body for molding expanded resin according to the invention.

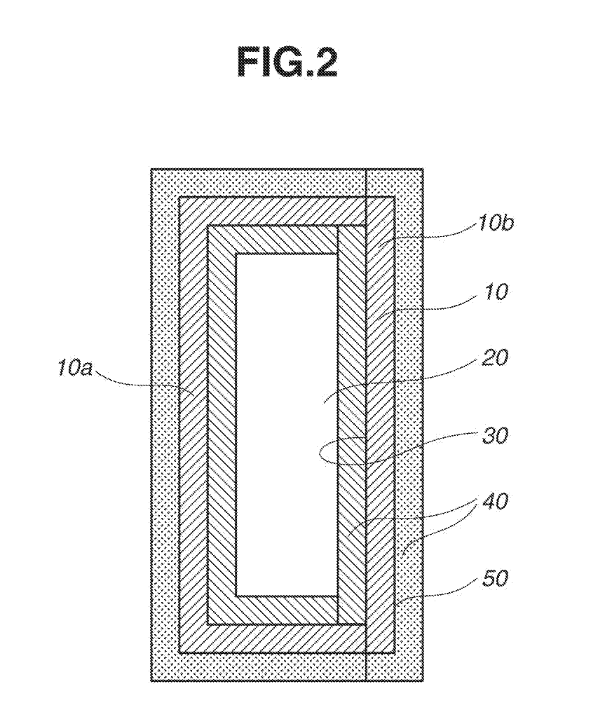

FIG. 2 is a schematic cross-sectional diagram showing another embodiment of a mold body for molding expanded resin according to the invention.

### EMBODIMENT FOR CARRYING OUT THE INVENTION

Referring to FIG. 1, the inventive mold for molding expanded resin has a mold body 10 with a cavity 20 defined by an inner wall 30 on part or all, and preferably all (that is, the entire surface of a frame and a back plate that form the inner wall), of which is formed a silicone rubber layer 40 as a heat-insulating layer.

As shown in FIG. 2, in addition to forming a silicone rubber layer 40 on part or all, and preferably all, of the inner wall 30 defining the cavity 20 of the mold body 10, where necessary, a silicone rubber layer 40 may also be formed on an outer wall 50 of the mold body 10.

Here, the mold body 10 has a frame 10a and a back plate 10b that is detachably provided on the frame 10a. The cavity 20 forms at the interior when the back plate 10b is set on the frame 10a. The cavity 20 is filled with an expandable feedstock through a nozzle (not shown) inserted airtightly through a side plate of the frame 10a. A steam feed line (not shown) is provided outside of the mold body 10 and heat from the steam is imparted to the expandable feedstock that has been filled into the interior of the cavity 20 through the mold body 10, whereupon the expandable starting material expands. After the expandable feedstock has thus been expansion molded, the steam is drawn off and removed and the expanded product is cooled, following which the back plate 10b is moved and separated from the frame 10a. The expanded product that has been molded is pushed out of the frame 10a by a mold release pin (not shown) and thereby recovered.

The mold body is formed of an aluminum material and the silicone rubber layer has a JIS-A hardness, determined according to JIS K 6249, of from 20 to 70, preferably from 40 to 70, and more preferably from 50 to 70. A JIS-A hardness that is too low is undesirable because the steam resistance is poor. On the other hand, a JIS-A hardness that is too high is undesirable because adhesion to the base material is poor and the heat-insulating effects decrease. When the silicone resin layer is formed to a JIS-A hardness, according to JIS K 6249, of at least 85, and especially 90 or more, cracking tends to arise and excellent heat-insulating effects are ultimately not obtained. As a result, silicone heat-insulating paints and the like which are composed primarily of a silicone resin having a so-called three-dimensional network structure that forms a film having a high hardness cannot be used.

It is recommended that the silicone rubber layer be formed to a thickness of 0.5 to 5 mm, preferably 1 to 3 mm, and more preferably 1.5 to 2.5 mm.

It is preferable to form the silicone rubber layer on the entire surface (all) of the cavity inner wall of the mold body. However, depending on the shape of the mold body cavity, the silicone rubber layer may be formed partially (i.e., on part of the cavity inner wall). Alternatively, when the silicone rubber layer is formed on the cavity outer wall, as shown in FIG. 2, it may be formed on the entire surface (all) of the outer wall or it may be formed on part of the outer wall.

When forming the silicone rubber layer on the cavity inner wall of the mold body made of aluminum, the method employed may consist of applying a liquid silicone rubber composition, especially a liquid room temperature-vulcanizable (RTV) silicone rubber composition, to the cavity inner wall of the mold body to the cured thickness of 0.5 to 5 mm mentioned above, and then drying and curing the applied composition.

In this case, the liquid silicone rubber composition applied onto the cavity inner wall of the mold body has a viscosity at 25° C., as measured with a rotational viscometer, of from 0.01 to 100 Pa·s, preferably from 0.1 to 50 Pa·s, and more preferably from 0.5 to 20 Pa·s. When the viscosity is too low, the required film thickness cannot be achieved; on the other hand, when the viscosity is too high, application takes time and is disadvantageous from the standpoint of workability, in addition to which a smooth surface cannot be achieved. Moreover, although it is preferable to use, as the liquid silicone rubber composition having such a viscosity, a solvent-free type of silicone rubber composition to which a diluting solvent is not added and which itself has a viscosity in the above range, a composition which, when diluted by adding a solvent, has a viscosity in the above range is acceptable. Hence, use can be made of a high-viscosity or solid silicone rubber composition which has been diluted with a solvent and brought to a viscosity in the above range. The rotational viscometer used may be, for example, a Brookfield (BL, BH or BS-type) viscometer, a cone and plate viscometer or a rheometer.

The liquid silicone rubber composition is not particularly limited, although compositions that are room temperature-vulcanizable (RTV) are preferred from the standpoint of workability and other considerations. Compositions of known formulations may be used. The type of curability (type of crosslinking reaction) is not particularly limited. Use may be made of a composition that is addition-curable, although one that is condensation-curable (condensation-type) is preferred. Suitable use can be made of a liquid RTV silicone rubber composition in which the base resin or base polymer is a linear organopolysiloxane wherein both ends of the molecular chain are capped with hydroxyl groups (silanol groups) or hydrolyzable groups (hydrolyzable group-containing triorganosilyl groups) and the backbone consists of recurring diorganosiloxane units, an organosilicon compound having three or more hydrolyzable group (e.g., an organosilane compound containing three or four hydrolyzable groups, and/or a partial hydrolytic condensate thereof) is included as a crosslinking agent, and curing catalysts, inorganic fillers (reinforcing silica, non-reinforcing silica, calcium carbonate, etc.) and/or tackifiers, etc. are also optionally included.

This condensation-type RTV silicone rubber composition is more preferably one in which the base polymer is a linear diorganopolysiloxane having two or more condensable reactive groups (e.g., diorganohydroxysilyl groups, or triorganosilyl groups having 1 to 3 hydrolyzable groups) per molecule (preferably on both ends of the molecular chain), and which, in the presence of a curing catalyst (condensation reaction catalyst), forms a rubbery film (silicone rubber) having a three-dimensional network structure by a condensation reaction with, as the crosslinking agent (curing agent), an organosilicon compound having three or more hydrolyzable groups. This RTV silicone rubber composition is not particularly limited, provided it has a condensation-type curing mechanism. Examples include those in which the hydrolyzable groups (curing-reactive functional groups) within the hydrolyzable group-containing linear diorganopolysiloxane serving as the base polymer are hydroxyl groups directly bonded to silicon atoms (silanol groups), alkoxy groups or the like. Aside from the hydrolyzable groups on the diorganosiloxane units making up the main chain, examples of organic groups (substituted or unsubstituted monovalent hydrocarbon groups) directly bonded to silicon atoms include alkyl groups such as methyl, aryl groups such as phenyl, or alkenyl groups such as vinyl. A one-component or a two-component RTV silicone rubber composition may be prepared by including at least one of the following with the above hydrolyzable group-containing linear diorganopolysiloxane serving as the base polymer: a polyfunctional silane compound having hydrolyzable groups (e.g., acyloxy groups such as acetoxy, alkoxy groups such as methoxy or ethoxy, ketoxime groups, enoxy groups (alkenyloxy groups), amide groups) bonded to three or more silicon atoms, and/or a partial hydrolytic condensate thereof (siloxane oligomer), as a crosslinking agent; and a metal organic acid salt (e.g., a naphthenate, octanoate, peroxide or organic amine of, for example, lead, iron, cobalt, manganese or zinc) as a curing catalyst. In addition, inorganic fillers (e.g., reinforcing silica, non-reinforcing silica, calcium carbonate), tackifiers (e.g., silane coupling agents having various types of functional groups with, for example, amino functionality, epoxy functionality, (meth)acrylic functionality, mercapto functionality) and the like may be included. At the same time as these compounds hydrolyze at room temperature or with heating, they three-dimensionally crosslink and cure via a condensation reaction such as an alcohol elimination, acetic acid elimination, oxime elimination or hydroxylamine elimination reaction. For easy workability, a one-component silicone rubber composition in a form that cures at a normal temperature is preferred, with a composition whose by-products generated during curing have little irritancy (such as an alcohol-eliminating composition or an oxime-eliminating composition) being most preferred. Illustrative examples of such condensation reaction-curable RTV silicone rubber compositions include the following commercial products: KE-44 RTV, KE-445 RTV, KE-4895 and KE-4896 (available under these trade names from Shin-Etsu Chemical Co., Ltd.); TSE387, TSE388 and TSE389 (available under these trade names from Momentive Performance Materials Inc.); and SE9187 and SE9186 (available under these trade names from Dow Corning Toray Silicone Co., Ltd.).

The silicone rubber composition may be a commercial product used directly as is or after dilution with a solvent.

The solvent used in dilution is not particularly limited, although preferred use can be made of an organic compound that is liquid at room temperature (25° C.), examples of which include aromatic hydrocarbon compounds such as toluene and xylene, aliphatic hydrocarbon compounds such as pentane and hexane, and alcohol compounds such as methanol and ethanol.

A commonly known method, such as optional priming of the aluminum mold body, followed by brush coating, roller coating or spraying, may be employed to apply the liquid RTV silicone rubber composition to part or all of the mold body inner wall and perhaps also to some or all of the outer wall. Brush coating and roller coating are preferred. The coating work such as brush coating or roller coating may involve applying a plurality of coatings in order to achieve the above-mentioned thickness. However, for good workability while ensuring a sufficient film thickness, the application of two coatings is preferred.

The drying and curing conditions following application of the liquid silicone rubber composition may be suitably selected according to the type of composition. For example, in the case of condensation-type RTV silicone rubber compositions, drying and curing may be carried out in air (open air) at 0 to 50° C., especially 10 to 35° C., and for a period of 1 hour to 7 days, especially 2 hours to 3 days.

The mold for molding expanded resin in which a silicone rubber layer (coating layer) has been thus formed as a heat-insulating layer can be suitably used to form a molded product of expanded polystyrene, particularly by a bead molding process. The molding process carried out using this mold may be a known method that is suitable for the type of resin.

For example, in cases where a molded product of expanded polystyrene is to be obtained, the expanded polystyrene molded product can be obtained by employing a known bead molding process in which the EPS feedstock is filled into the mold body cavity, then the mold body is heated with steam, thereby heating and melting the EPS beads and forming a molded product, subsequent to which the mold body is cooled and then opened and the molded product is removed from the mold. In steam heating, use can be made of, but is not limited to, 100° C. steam at a pressure of about 1 atmosphere, so long as the EPS beads melt well and form a molded product. After molding, cooling may be carried out to about 60° C.

Because the inventive mold for molding expanded resin has a high heat-insulating performance and good thermal efficiency, in cases where, for example, the mold body is heated with steam in order to obtain an expanded polystyrene molded product by the bead molding process, steam consumption can be reduced by about 20 to 30% relative to a mold that has not been provided with a heat-insulating layer,. As a result, the amount of fuel such as petroleum fuel used to carry out steaming can also be greatly reduced.

The resulting mold for molding expanded resin can be used in the production of, for example, trawl boxes, packaging, and building materials.

### EXAMPLES

The invention is illustrated more fully below by way of Working Examples and Comparative Examples, although these Examples are not intended to limit the invention. The viscosities are measured values obtained with a rotational viscometer.

### Working Example 1

A liquid room temperature-vulcanizable silicone rubber composition having a viscosity at 25° C. of 5 Pa·s was prepared by mixing together to uniformity 50 parts by weight of a linear dimethylpolysiloxane that was capped at both ends of the molecular chain with hydroxyl groups (silanol groups) and had a viscosity at 25° C. of 20,000 mPa·s, 50 parts by weight of calcium carbonate, 10 parts by weight of methyltris(methylethylketoxime)silane, 1 part by weight of 3-aminopropyltriethoxysilane and 0.1 part by weight of dibutyltin dilaurate, and then additionally mixing in 30 parts by weight of xylene.

The liquid room temperature-vulcanizable silicone rubber composition was applied by brush-coating twice onto the inner wall (entire surface) of an aluminum mold body for molding expanded polystyrene that had a cavity volume of 0.05 m3 and a wall thickness of 20 mm. After coating, the applied composition was left to stand in air at room temperature (25° C.) for 24 hours, thereby forming a silicone rubber layer (coating layer) having a thickness of 2 mm and a JIS-A hardness, determined in accordance with JIS K 6249, of 60.

The percent reduction in steam consumption when an expanded polystyrene molded product was formed using this mold body having a silicone rubber layer (coating layer) formed on the inner wall (entire surface) was evaluated by the following method. Here, the percent reduction in steam consumption is the ratio of reduction relative to the steam consumption when using a mold body on which a silicone rubber layer has not been formed on the inner wall (control steam consumption).

That is, a steam flow meter (FD-V40, from Keyence Corporation) was installed at the steam inlet provided on top of an aluminum mold frame and, after filling the cavity of the mold body with EPS beads serving as the starting material for the expanded polystyrene molded product, the amount of steam used (steam consumption) from the start of mold heating (start of heating step) with steam when introducing steam at approximately 100° C. and 1 atmosphere, thereby heating the EPS beads to at least about 90° C. and melting them to form an expanded polystyrene molded product, and thereafter up until heating with steam was ended (end of heating step) prior to the mold body cooling/demolding step (approximately 60° C.)—that is, the amount of steam used to heat the mold and keep it warm in a mold temperature range of from 60° C. (at start of heating) to 100° C. (at end of heating), was measured with the steam flow meter. Measurement was evaluated when the cycle from the start to the end of the heating step (i.e., the EPS molding cycle) had been carried out twice.

As a result, the steam consumption relative to a control value of 100 for steam consumption was about 70, indicating that steam consumption was reduced by about 30%.

### Comparative Example 1

A mold was used wherein, instead of forming a silicone rubber layer as in Working Example 1, a 3 mm thick EPDM rubber lining was provided on the inner wall of the mold body. The reduction in steam consumption when forming an expanded polystyrene molded product was evaluated in the same way as in Working Example 1. The EPDM rubber lining sheet had to be secured with bolts, but because attachment to the frame in this way was difficult, the lining sheet was bolted only to the back plate.

Using the mold body thus provided with an EPDM rubber lining sheet, steam consumption when an expanded polystyrene molded product was formed in the same way as in Working Example 1 was about 90 relative to a control value of 100 for steam consumption, indicating a reduction of about 10% in steam consumption.

On comparing the costs incurred when the EPDM rubber lining sheet is attached only to the back plate of the mold with the costs when a silicone rubber layer is formed on the entire surface (frame and back plate) of the mold body (Working Example 1), because attaching the EPDM rubber lining sheet to the back plate creates a need to improve the back plate, a rise in costs of about 100% (to approximately twice the cost) occurred. Also, from the standpoint of workability, the brush coating method of Working Example 1 was very easy and convenient.

### Comparative Example 2

An expanded polystyrene molded product was formed in the same way as in Working Example 1 using a mold wherein, instead of forming a silicone rubber layer as in Working Example 1, the entire surface of the mold body inner wall was spray-coated with a heat-insulating coating (KR-271, from Shin-Etsu Chemical Co., Ltd.) composed primarily of a silicone varnish (i.e., a silicone resin having a three-dimensional network structure). The coating thickness was 0.5 mm.

Steam consumption in this case was about 90 relative to a control value of 100 for steam consumption, indicating a reduction of about 10% in steam consumption.

### Comparative Example 3

Aside from using a silicone rubber composition that gives a cured product having a hardness according to JIS K 6249 of 85, which is higher than the hardness of the silicone rubber in Working Example 1, a mold body was manufactured in the same way as in Working Example 1. In the mold body having such a high-hardness silicone rubber layer formed therein, the coating material had an inadequate conformability to the mold during thermal cycling, as a result of which cracks readily formed.

### Comparative Example 4

Aside from using a silicone rubber composition that gives a low-hardness cured product having a hardness according to JIS K 6249 of 15, a mold body was manufactured in the same way as in Working Example 1. In this mold body, the coating material deteriorated under the influence of steam and readily developed cracks.

### REFERENCE SIGNS LIST p 10 Mold body

10a Frame

10b Back plate

20 Cavity

30 Inner wall

40 Silicone rubber layer

50 Outer wall

1. A mold for molding expanded resin, the mold being characterized by comprising a mold body that is made of an aluminum material and has an inner wall which defines a cavity and on part or all of which is formed, as a heat-insulating layer, a layer of silicone rubber having a JIS-A hardness of from 20 to 70.

2. The mold of claim 1, wherein a silicone rubber layer having a JIS-A hardness of from 20 to 70 is additionally formed on part or all of an outer wall of the mold body.

3. The mold of claim 1, wherein the expanded resin is expanded polystyrene which is molded by filling the cavity of the mold body with expandable polystyrene beads and steam-heating the mold body.

4. The mold of claim 1, wherein the silicone rubber layer has a thickness of from 0.5 to 5 mm.

5. The mold of claim 1, wherein the silicone rubber layer is a cured product of a room temperature-vulcanizable silicone rubber composition.

6. A method of manufacturing a mold for molding expanded resin, the method being characterized by applying, to part or all of at least a cavity-defining inner wall of a mold body which is adapted for molding an expanded resin and is made of an aluminum material, a liquid room temperature-vulcanizable silicone rubber composition that has a viscosity at 25° C. of from 0.01 to 100 Pa·s and gives a cured product having a JIS-A hardness of from 20 to 70, and then drying and curing the applied composition to form a silicone rubber layer as a heat-insulating layer on the inner wall.

7. The manufacturing method of claim 6, which further comprises applying the liquid room temperature-vulcanizable silicone rubber composition to part or all of an outer wall of the mold body, and then drying and curing the applied composition to form a silicone rubber layer on the outer wall.

8. The manufacturing method of claim 6, wherein the expanded resin is expanded polystyrene which is formed by filling the cavity of the mold body with expandable polystyrene beads and steam-heating the mold body to mold expanded polystyrene.

9. The manufacturing method of claim 6, wherein the silicone rubber layer has a thickness of from 0.5 to 5 mm.

10. The manufacturing method of claim 6 which is characterized by comprising the step of twice applying and drying the liquid room temperature-vulcanizable silicone rubber composition.
